(19) United States
(12) Patent Application Publication
(10) Pub. No.: US 2007/0084880 A1
(43) Pub. Date: Apr. 19, 2007

(54) Tube dispensing device

(76) Inventors: Eric William Wagner, Holly Springs, NC (US); Sean Patton Baker, Parker, CO (US)

Correspondence Address: Thomas A. O'Rourke;Bodner & O'Rourke, 425 Broadhollow Road, Melville, NY, 11747, US

(21) Appl. No.: 11/581,774

(22) Filed: Oct. 16, 2006

Related U.S. Application Data
(60) Provisional application No. 60/727,539, filed on Oct. 17, 2005.

(51) Int. Cl. B67D 5/08; B65D 35/28; B65D 88/54

(52) U.S. Cl. 222/52; 222/333; 222/103

(57) ABSTRACT

A tube dispensing device having a body, the body has a first end and a second end. The body is adapted to receive a tube, the tube has a dispensing end and a collapsible body. The body also has a first arm and a second arm. In addition, the body can cause the arms to come together when a collapsible body is between the arms, thereby forcing a product in the collapsible tube to be dispensed from the dispensing end of the tube. The tube dispensing device can have a motor. The motor can be operatively attached so as to dispense product when the motor is activated. The motor can be activated by either a button or a sensor. The tube dispensing device can have a base. The base can hold the body in a fixed position, either in a generally upward or generally downward direction.

This application claims priority from previously filed provisional application 60/727,539, filed on Oct. 17, 2005.

### FIELD OF THE INVENTION

The present invention is directed to improvements in dispensing products from tubular containers. These products can include pasty or semi liquid products such as toothpaste, cosmetics, hand cream, shaving cream, caulking and other products packaged in tubular containers.

### BACKGROUND OF THE INVENTION

Soft and pasty products are frequently packaged in collapsible tubes. At one time these tubes were made of lead. Because of concerns about the health effects of lead, these tubes were replaced with other materials. Lead, however, had one feature that was very advantageous in collapsible tubes. This advantage was known as a “dead fold”. Thus, as the product was being used, the bottom of the tube was folded up and the tube stayed folded and did not unravel. Thus a user could know that virtually all the product was being discharged. When the lead was replaced, plastic or various combinations of plastic and foil have been used.

Collapsible tubes have generally the same structure. There is a body made from a sheet material. The sheet material can be a single layer of a thermoplastic material or a multi-layer structure, such as a multi-layer laminate. In many laminate structures, there is a layer of a foil, for example, aluminum. On both sides of the aluminum layer, there is an adhesive and one or more thermoplastic layers thereon. The adhesive helps secure the foil layer to the outer thermoplastic layers. The sheet material is formed into a tubular member usually with a lap seam to seal the edge of the sheet material. The lap seam is usually formed contacting or overlapping the outer thermoplastic layer with the inner thermoplastic layer followed by an application of heat and pressure to seal the edges to form the tubular structure. A representative sheet material for use in a collapsible tube is depicted in FIG. 1. The sheet material is generally designated by the numeral 10. Layers 12 and 16 are metal foil layers. Layers 14 and 20 are polymer layers and are frequently ethylene polymers or co-polymers thereof. Layer 20 serves as a sealant layer to seal the sheet material to the headpiece of the tube. Layer 18 is a thin primer layer. Other layer structures can be used in the collapsible tube. There may be no foil layers or only a single foil layer. The tube may also be just a single layer of a thermoplastic.

FIG. 2 is a representation of a typical tube 110. The tube has a main body portion 112, a headpiece 114, a laminated sheet material 116 over the orifice and a cap 118. The sheet material is formed into a cylindrical tube. The headpiece is secured to the tube by an adhesive or RF heating or other means. Once the product has been injected into the tube, the base of the tube is crimped and heat sealed to prevent the product from leaking out.

One end of the tube has a headpiece 114 inserted onto the end. The headpiece is shown in more detail in FIG. 3. The headpiece 210 has an orifice 212, usually threaded for discharging product, a shoulder portion 214 and a breast 216 where the tube of sheet material is secured to the headpiece. If desired, the orifice may have a covering layer to protect the product. The covering layer may be a single layer or multi layer laminate.

The product in collapsible tubes is usually dispensed by exerting pressure on the sidewall of the tubes. The pressure causes the product to be dispensed from the orifice. Because the collapsible tubes are made from only a thin sheet metal or none at all, many tubes have at least some spring back when the pressure is released. This makes it difficult in many instances for the user to get all of the product from the collapsible tube. Many people try to fold up the tube, i.e. roll the tube up from the bottom to force product through the orifice. Because of the spring back, this does not always work. As a result, there is a need for better dispensing apparatus for discharging product from a collapsible tube.

Children are some of the more common users of collapsible tubes. Many parents seek ways to make sure that children practice good oral hygiene by regular tooth brushing. One way to increase brushing is to make the process interesting and fun. Other products can be dispensed from tubes as well. There is a need for dispensing devices that permit a user to use substantially all of the product in a tube. In addition, there is a need for a dispenser that is easy to use, as well as one that will keep a child's interest in the important task of brushing their teeth and the proper use of other products in the tube. As a result, there is a need to provide children and others with incentives to use the product in collapsible tubes, including brushing their teeth.

### OBJECTS OF THE INVENTION

It is an object of the invention to provide a device for dispensing product in a collapsible tube.

It is also an object of the invention to provide a dispensing device for discharging product from a collapsible tube that will be interesting for children to use.

It is another object of the invention to provide a dispensing device that will remove product from collapsible tubes and not leave a significant residue in the tube.

It is still a further object of the invention to provide a dispensing device for toothpaste and the like.

It is still another object of the invention to provide a dispensing device that may be used in most environments without the danger of electrical shock.

It is a still further object of the present invention to provide a dispenser that may be used for a variety of different products packaged in collapsible tubes.

These and other objects of the present invention will become apparent to those skilled in the art from a review from the description provided below.

### SUMMARY OF THE INVENTION

The present invention is directed to a dispensing device for soft, pasty or semi-liquid products. This includes toothpaste, cosmetics, lotions and the like. The device is an electrically driven dispenser that has a stand or base for supporting the device on a suitable surface. There is a body which is supported by the base. The body has an orifice or chamber that receives a tube of the product to be dispensed such as a toothpaste tube. Within the body, there is a first arm and a second arm that pivot around a pivot member. The pivot member is positioned at one end of each arm. As the pivot arms are moved closer together, product is dispensed from the tube. The arms can be moved by a motor or the movement can be manual. If a motor is used, the motor can be driven by a battery or by household current. The motor can drive one or more wheels that cause the arms to move towards each other or away from each other. If a motor is not used, the wheels can be positioned so that they are manually turned.

One advantage of the present is that there is no need to repeatedly remove and replace the cap of the tube that the product is contained. With conventional prior art tube dispensing systems the user has to remove and replace the cap after each use. There are multiple disadvantages with this type of dispensing system. For example, there is an increased likelihood that the user can inadvertently misplace the cap. This can cause the product to dry up, which can cause, waste of the product, impedance of product dispersion, and bacterial build up on the desiccated product. The present invention alleviates the pitfalls associated with conventional prior art dispensing systems by implementing a self sealing means. Thus, there is no chance of forgetting to seal the tube, or worse yet, lose the cap.

### BRIEF DESCRIPTION OF THE DRAWINGS

FIG. 1 is a representation of a sheet material structure useful in collapsible tubes.

FIG. 2 is a side view of a collapsible tube.

FIG. 3 is a side view of a head piece for a collapsible tube.

FIG. 4 is a side view of a portion of a collapsible tube with head piece.

FIG. 5 is a side view of the apparatus of the present invention.

FIG. 6 is a front perspective view of the apparatus of the present invention.

FIG. 7 is an end view of the dispenser body.

FIG. 8 is a schematic Diagram of the present invention

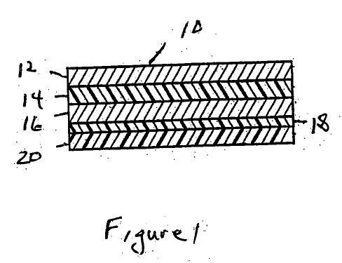

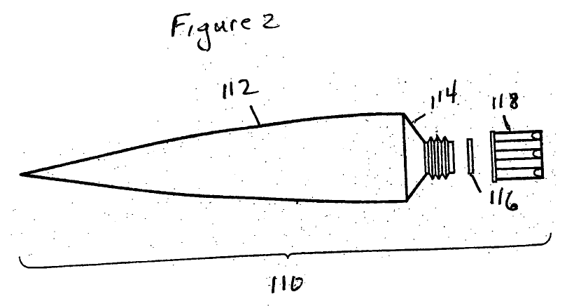

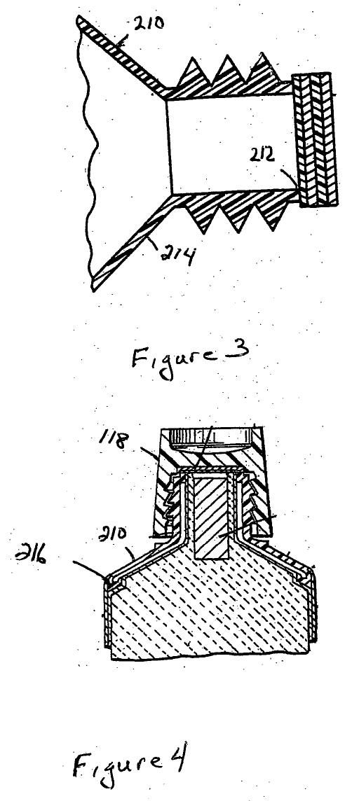

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

All citied references are incorporated herein by reference in their entireties. Citation of any reference is not an admission regarding any determination as to its availability as prior art to the claimed invention.

Turning now descriptively to the drawings, in which similar reference characters denote similar elements throughout the several views, the figures illustrate the present invention. The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

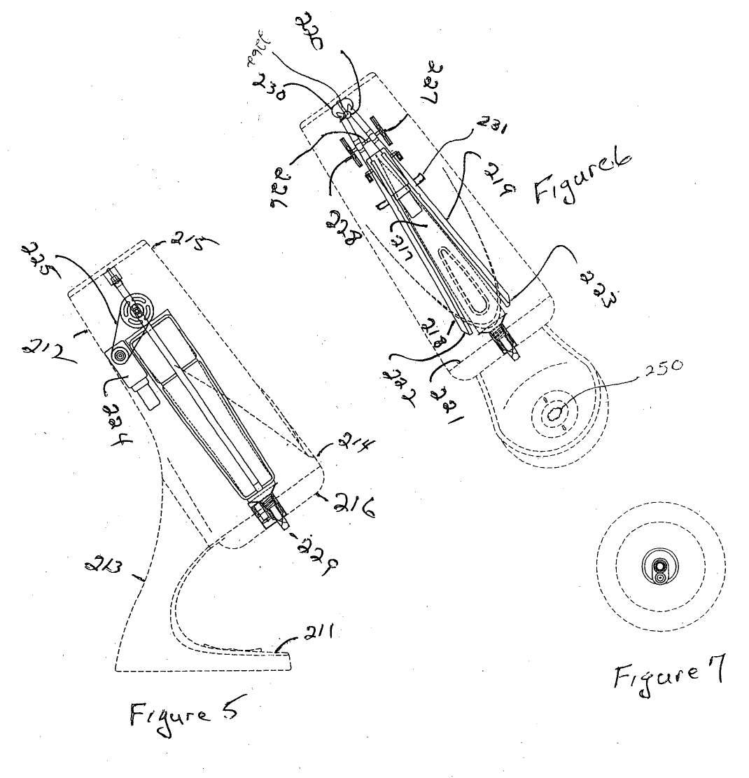

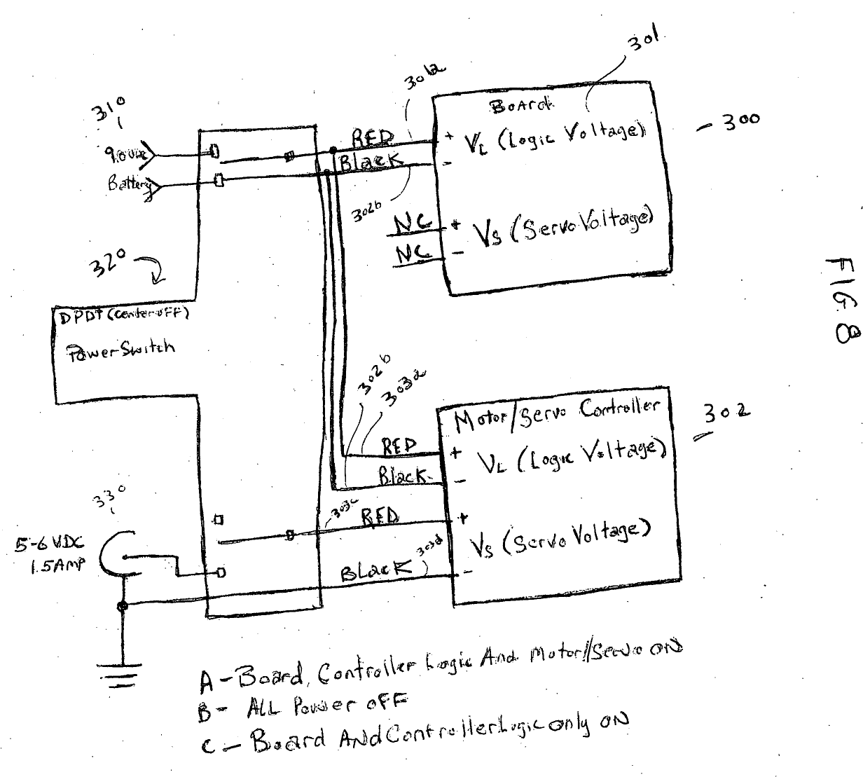

FIGS. 5-7 shows the dispenser 10 of the present invention. There is a base 211 that supports a body 212 by means of a leg 213. The base can have suction cups located on an underside of the base. This can help maintain the base in a fixed position so that it does not accidentally get knocked over. In an alternative embodiment the suction cups can be located elsewhere on the invention, so as to facilitate in fastening to a wall or cabinet. While one configuration is shown in the drawings, it will be appreciated that other configurations for the dispenser are possible. The dispenser can be in the form of a character or other shape. The dispenser can also be positioned so that the orifice is in an upward position. As mentioned above, the collapsible dispenser of the present invention may be used to dispense any soft, pasty or semi-liquid products. This includes toothpaste, cosmetics, lotions, shaving creams, hand and/or body creams and the like.

The body of the first dispenser has a first end 214 and a second end 215. The first end 214 has a removable cap 216 for inserting the collapsible tube 217. In an alternative embodiment tube insertion can be via an opening that can be located near the front or rear half of the body. The collapsible tube is inserted into the body for dispensing product from the tube. The body has a first arm or paddle 218 and a second arm or paddle 219. The two arms are secured together at one end by adjustable pivot member 220. The arms are arranged in generally a V shaped configuration with the wider portion of the V closer to the opening 221 in the body. The opposite end of the V is where the adjustable pivot member 220 is located. As the free end of the arms 222 and 223 are moved closer to each other, the force of the arms on the collapsible tube causes product to be discharged from orifice in the tube.

The arms are preferably generally flat members having a length and a width whereby the length is significantly larger than the width. The arms are generally about as long as the collapsible tube to be dispensed. Preferably the arms should have a length from about the end of the tube to the area of the tube just below the headpieces. The arms are preferably about as wide as the tube. The arms may be flat or have a slight concave shape for receiving the sidewall of the collapsible tube. These dimensions permit significant amounts of the product in the tube to be dispensed without unnecessary product remaining in the tube.

The arms may be moved together or apart as desired. In one embodiment, the arms may move manually by means of a threaded member 230. When the threaded member is turned in one direction, the arms become closer together. As the threaded member is released or turned in the opposite direction, the arms move further apart, thus permitting the collapsible tube to be released from the body of the dispenser.

In an alternative embodiment depicted in FIG. 5, there is a motor 224 for driving the arms. The motor has a belt 225 that turns the threaded pivot member in the direction desired. In one embodiment the motor can be battery operated, or in another embodiment the motor can be designed with a plug that can go into a standard wall outlet. In another embodiment the motor can be gear driven.

In yet another embodiment, the base of the present invention can be designed to be adaptable with different electric tooth brushes. For example, there can be an area on the base with a cadmium battery charger, similar to those implemented with the electric Oral-B tooth brush system. Or, there can be an area where one can place one's toothbrush, hair brush, clips, and any other article that is generally found in the bathroom area.

In another embodiment there can be a small light located near first end 214. This would be useful, for instance, if a fuse blew, causing the bathroom light to go out. In this case, one can simply switch on the light located on the tube dispenser, instead of first going to the fuse box.

In one embodiment, the pivot member has an axle 226 that passes through each of the arms toward one end of the arm. At one or more of the ends of the axle, there are drive wheels 227, 228 that may be driven by the motor to operate the arms. As the motor rotates, the belt turns at least one of the drive wheels, thus causing the arms to become closer together or further apart. The arrangement of the arms in the V shaped configuration permits the arms to squeeze the tube to discharge the product. It should be mentioned that there can be one drive wheel, thus making for a smaller unit. This would have particular utility where a smaller tube dispensing unit is desired, say, for example, when traveling. Also, in an alternative embodiment the belt driven motor can be replaced with a gear tooth driven motor.

The cap 216 for the body 212 may be a removable cap that is threaded or received and held by the body by any other suitable means, such as a friction fit or otherwise. The cap retains the collapsible tube in the dispenser. The cap preferably has an orifice 229 for the product to flow through.

As seen in FIG. 6, the arms have a length that extends from the second end of the body to virtually the first end thereof. At the end of the arms away from the opening, the arms may be secured together by a “C” shaped member 230 that prevents the arms from moving about in the body. The surface of each arm that faces the opposite arm may have a recess portion for receiving a pin or axle 226a about which the arms pivot. The axle is preferably threaded so that the arms can retract or extend as the driving wheels are turned either manually or by means of a motor.

In an alternative embodiment there can be a motion sensor 250 located near front end 214. Thus, when motion is detected by the sensor, the product will be automatically expelled. This embodiment is very useful when one of the user's hands is incapacitated. In this instance, the user just has to wave his/her free hand in front of the motion sensor. With this type of embodiment the invention can be designed to dispense a predetermined amount of product, or it can be designed to continuously dispense product until out of the sensing area.

In an alternative embodiment the present invention can be designed with audio capabilities. For example, in one embodiment there can be any one of the many children's cartoon characters, T.V personalities, and the like, programmed to say any one of a number of phrases. One example of one of the many phrases that can be programmed is “great job brushing your teeth, keep up the good work.”

In yet another embodiment, there can be a radio receiver and speakers located inside the base of the present invention. Thus, one can listen to the traffic and weather report while one is brushing one's teeth.

Drawing one's attention to FIG. 8 is an electrical schematic diagram of the present invention. The main electrical components of the present invention can include, a board 300, a board 302, a 9 VDC power supply 310, a single pole double throw switch 320 (hereinafter SPDT), and a 3-5 VDC power supply rated at 1.5 amps 330.

Board 300 includes the voltage logic 301 located at pins 301a and 301b. In the preferred embodiment pin 301a can be the positive lead and pin 301b can be the negative lead. In the preferred embodiment the pins 301c and 301d are not connected.

Board 302 can have pins 303a-d. Pins 303a and 303b of board 302 can be connected to pins 301a and 301b of board 300, respectively, these pins supply power to the logic voltage of both boards. In addition, board 302 can have pin 303c and 303d connected to the servo voltage.

In normal operation when SPDT switch 320 is in position “A”, power will be supplied to both logic boards and the motor servo, via 9 VDC 310, as can be seen from FIG. 8. When SPDT 320 is in position “B”, all power will be off. When SPDT 320 is position “C” power will be supplied to both logic boards, via 3-5 VDC 330, as can be seen from FIG. 8.

As various changes could be made in the above constructions without departing from the scope of the invention, it is intended that all matter contained in the above description shall be interpreted as illustrative and not in a limiting sense. In the view above it will be seen that several objects of the invention are achieved and other advantageous results attained, as defined by the scope of the following claims.

What we claim is:

1. A tube dispensing device comprising:
a body said body having a first end and a second end, said body adapted to receive a tube, said tube having a dispensing end and a collapsible body, said body having a first arm and a second arm, said body having a means to cause at least one of said arms to move towards the second arm when said collapsible body is between said arms thereby to force a product in said collapsible tube to be dispensed from said dispensing end of said tube.

2. The dispensing device according to claim 1 wherein said arms are joined by a pivot member.

3. The dispensing device according to claim 2 wherein said arms are capable of being moved by a threaded member said threaded member moving said arms in a first direction when said threaded member is turned in a first direction and in a second direction when said threaded member is turned in an opposite direction.

4. The dispensing device according to claim 3 wherein said first and second arms form a generally “V” shape.

5. The dispensing device according to claim 4 wherein said arms are generally flat members having a length and a width whereby the length are significantly greater than the width.

6. The tube dispensing device according to claim 5 wherein the length of said arms is generally about as long as the length of said collapsible body of said tube.

7. The dispensing device according to claim 6 wherein said arms have a length from at least the end of the collapsible tube to the area of the tube just below a headpiece of said tube.

8. The dispensing device according to claim 7 wherein said arms are at least as wide as the collapsible tube.

9. The dispensing device according to claim 8 wherein said arms have a slight concavity for receiving a sidewall of the collapsible tube.

10. The dispensing device according to claim 8 wherein said arms have a generally flat contact surface with said tube.

11. The dispensing device according to claim 8 further comprising a drive means.

12. The dispensing device according to claim 11 wherein said drive means is a motor.

13. The dispensing device according to 12 wherein said motor has a belt, said belt turning threaded member in the direction desired.

14. The dispensing device according to claim 8 wherein said drive means comprises one drive wheel attached to said arms, said drive wheel having an axle extending from said first arm to said second arm.

15. The dispensing device according to claim 14 wherein there are first and second drive wheels on opposite ends of said axle.

16. The dispensing device according to claim 14 wherein a belt turns said drive wheel in the desired direction.

17. The dispensing device according to claim 7 wherein said paddles are held together by a generally “C” shaped clip.

18. The dispensing device according to claim 17 wherein said clip is used for preventing said tube from moving out of alignment off said tube.

19. The tube dispensing device according to claim 1 further comprising a cap for securing said tube in said body.

20. The dispensing device according to claim 19 wherein said cap is threaded.

21. The dispensing device according to claim 19 wherein said cap is held by the body by a friction fit.

22. The dispensing device according to claim 19 wherein said cap has an orifice for a product to flow through.

23. The dispensing device according to claim 7 wherein said body has a base attached thereto for supporting said body.

24. The tube dispensing device according to claim 23 wherein said base supports said body so that the end of said body which dispenses product is in a closer proximity to said base than the opposite end of said body is to said base.

25. The tube dispensing device according to claim 7 wherein there is a sensor for sensing when to dispense said product from said device.

26. The dispensing device according to claim 18 wherein said sensor is a motion sensor.

27. The dispensing device according to claim 20 wherein said product is toothpaste.

28. The dispensing device according to claim 20 wherein said product is hand cream.

29. The dispensing device according to claim 20 wherein said product is shaving cream.

30. The dispensing device according to 12 wherein said motor has a gear, said gear turning threaded member in the direction desired.

31. The dispensing device according to claim 14 wherein a gear turns said drive wheel in the desired direction.

32. The dispensing device according to claim 25 wherein a predetermined amount of product will be dispensed.
